(19) United States
(12) Patent Application Publication
(10) Pub. No.: US 2026/0015805 A1
(43) Pub. Date: Jan. 15, 2026

(54) Paving Management System and Operation

(71) Applicant: Caterpillar Paving Products Inc., Brooklyn Park, MN (US)

(72) Inventors: Nathaniel S. Doy, Clayton, NC (US); Nicholas A. Greene, Elk River, MN (US); Paul R. Friend, Morton, IL (US)

(73) Assignee: Caterpillar Paving Products Inc., Brooklyn Park, MN (US)

(21) Appl. No.: 18/767,180

(22) Filed: Jul. 9, 2024

(51) Int. Cl. E01C 19/28; B64U 10/14; B64U 101/00; E01C 19/26; E01C 19/48

(52) U.S. Cl. CPC E01C 19/282; E01C 19/26; E01C 19/4873; B64U 10/14; B64U 2101/00

(57) ABSTRACT

A computer-implement paving management system and operation utilizes autonomous mobile compactors to conduct the subordinate compacting operation on a paving mat laid by a paver. To activate the autonomous mobile compactors, one or more worksite sensors obtain thermal data about the paving mat. The thermal data obtained from the worksite sensor is converted to an assessed temperature value associated with the paving mat and the assessed temperature value is compared with a compaction temperature setting. The paving management system and operation activates and/or deactivate the autonomous mobile compactors based on the comparison between the assessed temperature value and the compaction temperature setting.

### TECHNICAL FIELD

This patent disclosure relates generally to the compaction of paving materials laid over a terrain and, more particularly, to operating an autonomous compactor as part of a paving operation.

### BACKGROUND

A continuous paving operation for the creation of roadways and similar surfaces may involve the coordinated operation of several types of mobile machines. The various machines can be individually adapted to conduct specific operations to lay down and produce a paved surface of asphalt or concrete upon a base surface. The mobile machines may be in a sequential arrangement referred to as a paving train that simultaneously travel over the base surface to deposit and prepare a solid mat of the paving material that may be further shaped and contoured. After hardening, the paving material forms a durable surface resistant to wear and environmental conditionals and that supports various types of foot or vehicle traffic.

Mobile machines comprising the paving train may include pavers that receive and distribute or lay down the paving material over the base surface to produce the initial paving mat. Thereafter, a process or step referred to as compaction is undertaken to compress the paving mat into a dense, solid surface. Compaction, in particular, is the application of forces to the paving mat to make it denser, and thus harder and more resistive to wear. Compaction may be performed by one or more mobile compactors that follow the paver by traveling over the recently laid paving mat. The mobile compactors may include one or more rotating cylindrical drums that roll over the paving mat such that the weight of the compactor compresses the paving material into the denser finished paved surface. In some instances, the mobile compactors may make several passes over the same length of the paving mat, and may travel over the paving mat at different stages of compaction while the paving material has different and changing characteristics.

The characteristics of the paving material may vary significantly and may substantially change between the initial depositing of the paving mat and the finished formation of the paved surface. Accordingly, coordination and communication about the paving material and operations is required between the plurality of mobile machines for effective operation of the paving train. Further, there is a tendency to automate some or all of the operational aspects of the mobile machines functioning as part of a paving train. For example, U.S. Publication No. 2023/0343144 describes a system and method for generating multi-dimensional maps that may be used by mobile machines during a paving and compacting operation, including some of which may be autonomous machines.

### SUMMARY

The disclosure describes, in one aspect, a method of autonomous paving to fabricate a paving mat with one or more autonomous mobile compactors. The method involves distributing a paving material from a paver over a base surface to produce the paving mat. Thermal data about the paving mat is obtained from a worksite sensor that may include an infrared thermometer. The method generates a paving map of the paving mat including an assess temperature value that is derived from the thermal data. The method can activate the autonomous mobile compactor to compact the paving mat if the assessed temperature value corresponds with a compaction temperature setting.

In another aspect, the disclosure describes a computer-implemented paving management system that includes one or more worksite sensors for measuring thermal data about a paving mat and a central worksite server that receives and processes the thermal data from the worksite sensors. The central worksite server can be configured to generate a paving map of the paving mat including an assessed temperature value based on the thermal data. The central worksite server is further configured to compare the assessed temperature value with a compaction temperature setting and to activate operation of an autonomous mobile compactor upon correspondence between the assessed temperature value and the compaction temperature setting.

### BRIEF DESCRIPTION OF THE DRAWINGS

FIG. 1 is a side elevation view of a paving operation conducted by a plurality of mobile paving machines arranged in a paving train coordinated by an offboard worksite server to create a paving mat.

FIG. 2 is a schematic representation of the paving map associated with the paving mat for coordinating operation of one or more autonomous mobile compactors based on assessed temperature values.

FIG. 3 a flow diagram of a possible method for generating the paving map including the assessed temperature values of the paving mat that may be used for controlling operation of the autonomous mobile compactor.

### DETAILED DESCRIPTION

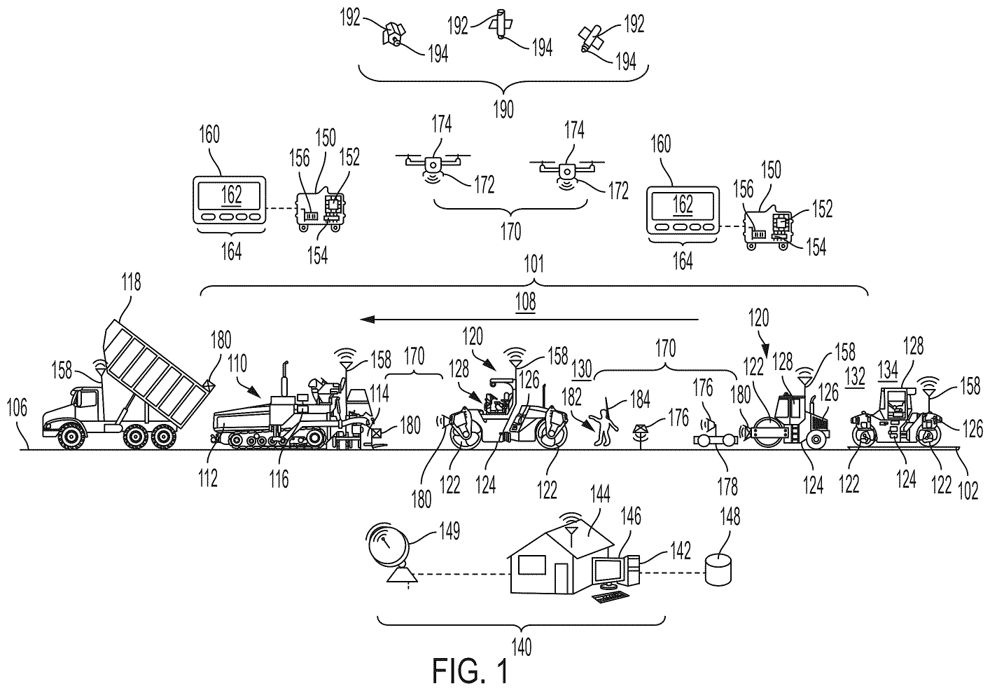

Now referring to the drawings, wherein whenever possible like reference numbers will refer to like elements, there is illustrated in FIG. 1 an example of a road working operation and particularly a paving train involving different machines and activities at a worksite 100 to produce a finished paved surface 102 such as a roadway or a parking lot. The paved surface 102 can be produced from paving materials such as asphalt or cement initially distributed in a paving mat 104 laid over a terrain substrate or base surface 106 that may be graded and contoured and have different slopes and elevations. The base surface 106 can be made from an unbound granular material and functions as the foundation or base for the paved surface 102.

To construct the paved surface 102, the paving mat 104 can be systematically processed by the plurality of mobile machines 101 cooperatively interacting with one another as a paving train to distribute and process the paving material over the base surface 106. During the road working operation, the plurality of mobile machines 101 may make one or more passes over the base surface 106 in what can be referred to as the travel direction 108. The paving mat 104 is therefore continuously distributed over the base surface 106 along the travel direction 108, and include linear segments, curves, inclines and slopes as may characterize the finished paved surface 102 such as a roadway. In addition to roadways, aspects of the disclosure may be applicable to other types of worksites 100 including mines or quarries, construction sites, and the like.

The paving material that is deposited as the paving mat 104 over the base surface 106 can be in a granular or semi-solid state such as asphalt, concrete or other aggregates and the like that may be mixed with binders like bitumen. To apply and evenly distribute the paving material over the base surface 106, a mobile machine 101 referred to as a paver 110 can operate at the worksite 100. The paver 110 can an include a forward mounted hopper 112 that can receive the paving material and is operatively associated with a screed 114 attached at the rear end to spread and distribute the paving material over the base surface 106 in the continuous paving mat 104. The paver 110 and screed 114 are configured to meter and distribute the paving material in the desired quantities, dimensions, and topology characterizing the paving mat 104.

The screed 114 may be towed behind the paver 110 to apply various directional forces to the material discharged therefrom to flatten and smooth out the paving mat 104. To convey material between the hopper 112 and the screed 114, an internal continuous conveyor 116 may be disposed through the paver 110 longitudinally between the front and the rear. The conveyor 116 includes a belt that continuously travels in a closed loop through the paver 110 carrying and depositing paving material before the screed 114. In an embodiment, an auger may be attached across the rear of the paver 110 to spread the paving material traversely across the width of the paving mat 104.

To deliver the paving material to the paver 110, a mobile machine 101 in the embodiment of a haul truck 118 can travel about the work site 100. The haul truck 118 can include a haul body that is pivotally mounted to a frame and that can be tilted upwards to discharge the paving material carried therein. The haul truck 118 can discharge paving material directly to the hopper 112 of the paver 110, although in other arrangements, a mobile machine referred to as material transfer vehicle (MTV) can transfer material disposed in piles about the worksite 100 to the hopper 112. The haul truck 118 can be adapted to travel from the worksite 100 to obtain and transport paving materials from a remote preparation site such as an asphalt plant wherein it may receive the recently prepared paving material at elevated temperatures.

To compress the loosely combined aggregate of the paving material after it has been deposited on the base surface 106 by the paver 110, one or more mobile compactors 120 can travel over the paving mat 104 in the travel direction 108. The mobile compactors 120 typically include one or more compaction rollers 122 that are shaped as large cylindrical drums and that are rotationally attached to a compactor chassis 124 by bearings.

As the mobile compactor 120 moves over the paving mat 104 in the travel direction 108, the rolling action of the compaction rollers 122 and the downward force resulting from the weight of the mobile compactor 120 compresses the aggregate asphalt or other paving material disposed on the base surface 106 thereby reducing volume and eliminating air voids in the aggregate. Air voids in the paving mat 104 are undesirable because air voids enable the material of the finished paved surface 102 to become unbound and disintegrate. Compacting of the paving mat 104 by the mobile compactors 120 produces a denser, wear resistant paved surface 102 and may further enable runoff of precipitation.

To propel the mobile compactor 120, a power source 126 can be disposed on the compactor chassis 124 and can be operatively connected to deliver a motive force to drive the compaction rollers 122. The power source 126 may be an internal combustion engine that combusts a hydrocarbon-based fuel to convert the latent chemical energy therein to motive power characterized by torque and rotation. Another example of a power source 126 can be an electrical system such as a battery or fuel cell storing or generating electrical energy and that is operatively associated with a traction motor to convert the electrical power to rotational torque to drive the compaction rollers 122.

In an embodiment, the mobile compactor 120 can include an onboard operator station 128 that is situated on the compactor chassis 124 in an elevated position to provide visibility over the worksite 100. The operator station 128 can also accommodate one or more operator input controls that enable an operator to control operation of the mobile compactor 120. Examples of operator input controls can include steering devices for navigating the mobile compactor 120, directional controls to change the direction of travel with respect to the travel direction 108 in forward and reverse, velocity and speed controls such as an accelerator and brakes, which may be embodied as depressible pedals, etc.

In an embodiment, the mobile compactor 120 configured for fully autonomous, semiautonomous, or manual operation. In fully autonomous operation, the mobile compactor 120 is operated by conducting assigned work tasks by responsively reacting to the environmental conditions and activities without the assistance of a human operator. In semiautonomous operation, a human operator who may be present on the machine or may be at a remote location and may be responsible for directing the machine to perform certain tasks which may be assisted with guidance or partial control from a control system operatively associated with the mobile compactor 120. In manual operation, the operator located in the operator stations 128 is generally responsible for directing all tasks performed by the mobile compactor 120.

To improve the quality of the finished paved surface 102 through optimal compacting of the paving mat 104, the compacting operation may be separated into distinct stages or steps. The compacting stages may be associated with the changing physical properties, including the material temperature, of the paving material forming the paving mat 104. The plurality of mobile compactors 120 can be specifically configured and designed for the distinct states of the compacting operation.

For example, the compacting operation may include a “breakdown” stage during which the paving mat 104 recently laid down by the paver 110 is relatively hot and the granular aggregate of paving material is loosely bounded and relatively deformable. The paving mat 104 is therefore readily susceptible to a significant degree of compaction to eliminate the air voids and increase the density and thereby “breakdown” the paving mat. During the breakdown stage, the elevated temperature of the paving material may range from approximately 300° F. (150° C.) to approximately 240° F. (115° C.). The temperature of the paving mat 104 may be within this elevated range since the paving materials were just supplied from the haul truck 118 and distributed by the paver 110.

To conduct the “breakdown” stage of the compaction operation, one of the mobile compactors 120 can be configured as a breakdown compactor 130 to apply significant compaction forces to the still hot paving mat 104 just after it has been deposited by the paver 110 onto the base surface 106. The breakdown compactor 130 can be characterized as having forward and rearward compaction rollers 122 constructed of large diameter steel cylinders. The breakdown compactor 130 may also be relatively heavy to apply correspondingly significant compaction forces to the paving mat 104 due to its weight. To increase the breakdown compaction forces, the compaction rollers 122 can be vibratory rollers having internal eccentric weights that generate vibratory forces when rotated inside the cylindrical steel casings of the compaction rollers. The generated vibration forces are directed downward against the paving mat 104 amplifying the compaction forces.

The breakdown compactor 130 should be aligned with and follow closely behind the paver 110 so that the temperature of the recently laid paving mat 104 is still elevated and has not significantly cooled, and thus the greatest degree of compaction can be achieved. For example, the distance between the breakdown compactor 130 and the paver 110 in the travel direction 108 can be maintained so that the temperature of the paving mat 104 is within the optimal range.

After the “breakdown” stage, the temperature of the paving material may enter an “tender” stage in which the paving material becomes resistant to compaction. For example, in the “tender” state, the paving material will tend to laterally displace or shovel in forwardly directed waves in response to the rolling action of the advancing compactor roller 122 rather than compress underneath the mobile compactor 120. When the temperature of the paving mat 104 is in the “tender” stage, compacting is difficult and should be avoided. The temperatures of the paving material during the “tender” stage may be within a range from approximately 240° F. (135° C.) to approximately 190° F. (90° C.), although the specific ranges of the “tender” zone are highly dependent upon the characteristics and properties of the paving material mix, including the granularity and consistency of the aggregate material.

When the temperature of the paving material has cooled below the “tender” zone, the paving operation may enter an “intermediate” stage in which the paving mat 104 is again susceptible to compaction and can support the weight of a mobile compactor 120 without laterally displacing. The “intermediate” stage of the compaction operation can be conducted by one or more intermediate compactors 132 that follow behind the breakdown roller 130 in the travel direction 108 at an appropriate distance to avoid the “tender” stage of the paving mat 104. The intermediate compactors 132 can be characterized as having one of the compactor rollers 122 configured as a pneumatic roller having a cylindrical casing made of rubber materials. The pneumatic roller can assume a temperature similar to the paving mat 104 so as avoid picking up or sticking of the paving material to the compactor roller 122. The temperatures associated with the “intermediate” stage may begin at approximately 190° F. (90° C.).

The compacting operation can also include a “finishing” stage at which the temperature of the compacting mat 104 is in the lower ranges during which any degree of compaction can be achieved. During the “finishing” stage, a finishing compactor 134 can travel over the paving mat 104 in the travel direction 108 behind the intermediate compactor 132. The finishing compactor 134 can be characterized as having a dual drum configuration with first and second steel static (non-vibratory) compactor rollers 122. The finishing compactor 134 is designed to remove any marks and smooth out the surface of the paving mat 104 before hardening into the final paved surface 102.

To coordinate and facilitate the operations of the plurality of different mobile machines 101 in the paving train and the different activities at the worksite 100, a computer implemented paving management system 140 can be associated with and responsible for the paving operation. The paving management system 140 can be configured to receive and collect information and data from various sources and to analyze and process the collective data to responsively direct and command operation of the mobile machines conducting the paving operation. The computer implemented paving management system 140 can be maintained by the fleet operator of the plurality of mobile machines 101, the construction firm responsible for the paving operation, or may be maintained by an application service provider (ASP) or through independent contractors.

The paving management system 140 can be embodied as a computer executable software application and the associated computing hardware and resources for supporting the ongoing paving operations and activities at the worksite 100. In an embodiment, the paving management system 140 can be an enterprise-wide communications network system that communicatively links the different mobile machines 101 and activities of the worksite 100.

To provide a centralized network node for communications, the paving management system 140 can include a central worksite server 142 that includes the computer hardware and software that provides functionality and resources maintaining, implementing, and supporting the paving management system 140. The central worksite server 142 may be located offboard with respect to the mobile machines and can be associated with a building or structure 144 located at the worksite 100. The building or structure 144 can accommodate one or more operators and worksite technicians responsible for overseeing and conducting the paving operation. In other embodiments, the central worksite server 142 can be located remotely from the worksite 100 and can be operatively associated with a plurality of worksites.

The central worksite server 142 can including the computer hardware, including microprocessors and memory, which hosts software applications and programming and can provide supplemental processing capabilities that can be accessed and used by other computing systems at the worksite 100. The worksite server 142 can serve as a central network node for communications and can function as a central repository for collection of data. The worksite server 142 can control access to worksite data and computational resources utilized by other systems with which it is networked. The worksite server 142 can administer and manage assignments and tasks related to worksite activities and operations to the plurality of mobile machines and other equipment. The worksite server 142 can also be configured and programmed to identify operational errors and faults and to resolve such problems and discrepancies. The worksite server 142 can function as the control center for the worksite 100.

To interface with worksite personnel, the worksite server 142 can include data entry terminals 146 and peripherals such as display monitors, keyboards and tracking mice for the entry and presentation of data. The data entry terminals 146 provide the input/output functionality for the paving management system 140. Although the worksite server 142 is illustrated as a single standalone unit at a single location, the hardware and functionality may be distributed among different devices at multiple locations.

The worksite server 142 can include a data storage 148 that contains and maintains computer readable data about the operations and activities of the worksite 100. The data storage 148 can be associated with a relational database or the like that receives and stores operational data and information received from the ongoing activities at the worksite 100 and can that include addressable memory locations for the storage of data and information in a computer readable format. The data storage 148 can also store supplemental data and information in the form of definitions, logic rules, formulas, instructions and commands, for processing during execution of the paving management system 140 that can stored in the form of lookup tables, data maps, instructions sets, etc.

To communicate with the plurality of mobile machines and personnel conducting activities about the worksite 100, the paving management system 140 can be operatively associated with a worksite telematics system including one or more worksite transceivers 149 for sending and receiving information via transmitted data signals. The worksite transceivers 149 can be located at various exposed positions about the worksite 100 and can broadcast and receive wireless communications through radio waves over sufficient distances to cover the worksite. The worksite transceivers 149 can use any suitable wireless protocol or standard such as Wi-Fi.

To intelligently interact with the paving management system 140, the plurality of mobile machines 101 comprising the paving train can be each operatively associated with an onboard electronic controller 150, which may also be referred to as an electronic control module (“ECM”) or electronic control unit (“ECU”). The electronic controller 150 can be a programmable computing device and can include one or more microprocessors 152 for executing software instructions and processing computer readable data. Examples of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip. Although illustrated as a single component, in other embodiments, the functionality of the electronic controller 150 may be distributed among a plurality of separate components.

To store application software and data, the electronic controller 150 can include a non-transitory computer readable and/or writeable data memory 154, for example, read only memory (“ROM”), random access memory (“RAM”), EPROM memory, flash memory, or another more permanent storage medium like magnetic or optical storage. The data memory 154 is capable of storing software in the form of computer executable programs including instructions, definitions, and electronic data for the operation of the mobile machine. The programs can include equations, algorithms, charts, maps, lookup tables, databases, and the like.

To interface and network with other operational systems, the electronic controller 150 can include an input/output interface 156 to electronically send and receive non-transitory data and information. The input/output interface 156 can be physically embodied as data ports, serial ports, parallel ports, USB ports, jacks, and the like to communicate via conductive wires, cables, optical fibers, or other communicative bus systems. To communicate with other operational system, the electronic controller 150 can utilize any suitable forms of communication protocol for data communication including sending and receiving digital or analog signals synchronously, asynchronously, or elsewise. For example, to exchange data communications with the central worksite server 142, the onboard electronic controller 150 can be associated with an onboard transceiver 158 mounted on the chassis of the mobile machines and electrically connected via the input/output interface 156.

To interface with an operator or worksite technician, onboard electronic controller 150 can be operatively associated with an operator interface display 160, also referred to as a human-machine interface (“HMI”). The operator interface display 160 can be an output device to visually present information to a human operator regarding operation of the mobile machine 120, the paving operation, and the other activities at the worksite 100. The operator interface display 160 can be a liquid crystal display (“LCD”) 162 capable of presenting numerical values, text descriptors, graphs, charts and the like regarding operation. The operator interface display 160 may have capacities such as a touchscreen to receive input from a human operator, although in other embodiments, other interface devices may be included such as keypads 164, dials, knobs, switches, keyboards, mice, printers, etc.

To collect data and information about the paving operation, the worksite management system 140 can be operatively associated with one or more worksite sensors 170 distributed about the worksite 100. The worksite sensors 170 can be any suitable devices for detecting events, conditions, or changes in an environment and signaling that information or data to another system and/or outputting it directly to an observer. Examples of sensors 170 include force sensors, spatial sensors such as rangefinders, acoustic sensors, light or image sensors, electrically conductive or resistive sensors, etc.

For example, the worksite sensors 170 can be located and configured to measure and obtain data and information about the physical properties and characteristics of the paving mat 104. Examples of sensed information may include the temperature, density and geometric dimensions associated with the paving mat 104. The data and information can be obtained during or indicative of the different stages of the subordinate compaction operation including the “breakdown,” “tender,” “intermediate,” and “finishing,” stages.

To enable the collection of data and information during the different compacting stages during the development of the paving mat 104, the work sensors 170 can include one or more aerial sensors 172 that can be mounted to an airborne machine 174 such as a drone. For example, the airborne machine 174 can be a quadcopter having four rotating props that enable the airborne machine to maneuver and hover over the worksite at an appropriate elevation to observe the paving operation and other activities. However, the airborne machine 174 can have any other suitable design to fly above the worksite. The airborne machine 174 can maneuver to different locations above the paving mat 104 to make various measurements of its characteristics and properties.

The aerial sensor 172 mounted to the airborne machine 174 can be configured measure from a distance information about the paving mat 104 such as temperature and density. For example, to measure the temperature, the aerial sensor 172 can be an infrared sensor or thermographic camera that is sensitive to the thermal heat radiating from the paving mat 104. The aerial sensor 172 can therefore capture the current temperature at specific locations of the paving mat 104 at specific locations. In other examples, the aerial sensor 172 can measure temperature of the paving mat by other suitable techniques. In addition, the aerial sensor 172 can be configured to measure properties like density using reflective techniques applying sound or radiofrequency waves.

In another example, the worksite sensors 170 can include one or more terrestrial based sensors 176 that can be fixedly mounted about the worksite 100. The terrestrial based sensors 176 can be attached to posts that are anchored to the base surface 106 alongside the paving mat 104 to measure the characteristics like temperature, density, dimensions, etc. In a further example, for mobility, the terrestrial sensor 176 can be mounted to a rover 178, which may be unmanned wheeled vehicle that may be self-propelled to travel about the worksite to different locations with respect to the paving mat 104. The rover 178 can be remote controlled or automated and can be positioned sufficiently low to the surface of worksite to obtain measurements from the paving mat 104. Depending upon temperature, the rover 178 may travel on top of or alongside the paving mat 104.

In another example, the worksite sensors 170 can be machine-based sensors 180 physically associated with the mobile machines 101. The machine-based sensors 180 can make direct measurements about the operating conditions or about the environmental characteristics and properties associated with the mobile machine. The machine-based sensors 180 can also be virtual sensors that indirectly estimate or derive information from the operational settings of the mobile machines.

For example, a machine-based sensors 180 can be mounted to the compactor chassis 124 and can be oriented to measure characteristics of the paving mat 104 proximate to the mobile compactor 120. The machine-based sensors 180 therefore measure characteristics of the paving material just before, during, and immediately after compaction. For example, to measure the temperature of the paving mat 104 proximate to the mobile compactor 120, the machine-based sensors 180 can be infrared thermal sensors or heat scanners.

In another example, the machine-based sensors 180 can be configured to measure the density of the paving mat proximate to the mobile compactor 120 to determine the degree of compaction. To measure the density, the machine-based sensors 180 can be resistive forces sensors that measure the resistance to propulsion of the mobile compactor 120 over the worksite caused by the presence of un-compacted material on the paving mat 104. For example, the aggregate asphalt in the un-compacted state presents greater rolling resistance to the rotation of the compaction rollers 122 on the mobile compactor 120, thus necessitating that the mobile compactor expend more energy to propel itself with respect to the paving mat 104.

In another example, the machine-based sensors 180 can be vibration sensors that measure vibratory forces reflected from the paving mat 104. For example, the mobile compactor 120 can be a vibratory compactor directing vibratory forces from the compaction roller 122 to the paving mat 104. If the paving mat 104 is in the un-compacted state, the imparted vibration forces will be substantially dissipated during compaction. If the paving mat 104 is in the compacted state, i.e., denser material, a substantial portion of the vibration forces may be reflected back to the mobile compactor 120. The machine-based sensor 180 can sense the magnitude of the reflected vibration forces to determine if the mobile compactor 120 is traveling over compacted or un-compacted material.

In another example, the machine-based sensors 180 can be associated with the paver 110 and can measure the temperature, quantity, and consistency of the paving material distributed by the screed 114. The machine-based sensor 180 on the paver 110 can also estimate the density of the paving mat 104 produced by the screed 114 based on the other measured values that can be indicative of the presence and volume of the air voids in the paving material.

The machine-based sensors 180 can also be associated with the haul truck 118 and can provide temperature and material measurements of the paving material as it arrives from the asphalt plant or other distribution center. To obtain additional information about the paving materials, the paving management system 140 can receive material data from the asphalt plant or distribution center concerning the paving material mix, constituents, granularity, particle size, binder composition, etc. The paving material data can be input to the paving management system using the data entry terminals 146 or can be received electronically through the worksite transceivers 149.

In another example, the worksite sensors 170 can be associated with worksite personnel 182 and technicians moving about the worksite 100. The worksite personnel 182 can carry portable personnel sensors 184 that make measurements of the properties and characteristics of the paving mat 104 at different locations and compaction stages such as temperature and density. The personnel sensors 184 can communicate those measurements with the worksite server 142 through the worksite transceiver 149 using a suitable communication medium such as, for example, radio frequency (RF) waves.

To determine the positions of the mobile machine and the various worksite sensors 170 located about the worksite 100, the paving management system 140 can be associated with a position determining system that may be implemented in any suitable form. For example, the position determining system can be realized as a global navigation satellite system (GNSS) or global positioning satellite (GPS) system 190. In the GNSS or GPS system 190, a plurality of manmade satellites 192 orbit about the earth at fixed or precise trajectories. Each satellite 192 includes a positioning transmitter 194 that transmits positioning signals encoding time and positioning information towards earth. By calculating, such as by triangulation, between the positioning signals received from different satellites, one can determine their instantaneous geographic location on earth. In the present embodiment, the transceivers on the plurality of mobile machines 101 and/or associated with the worksite sensors 170 can be configured to receive the positioning signals from the positioning transmitters 194. The GNSS or GPS system 190 can also communicate with the worksite transceiver 149 to communicate the positions and geographic locations of the mobile machines 101 and the worksite sensors 170 to the paving management system 140.

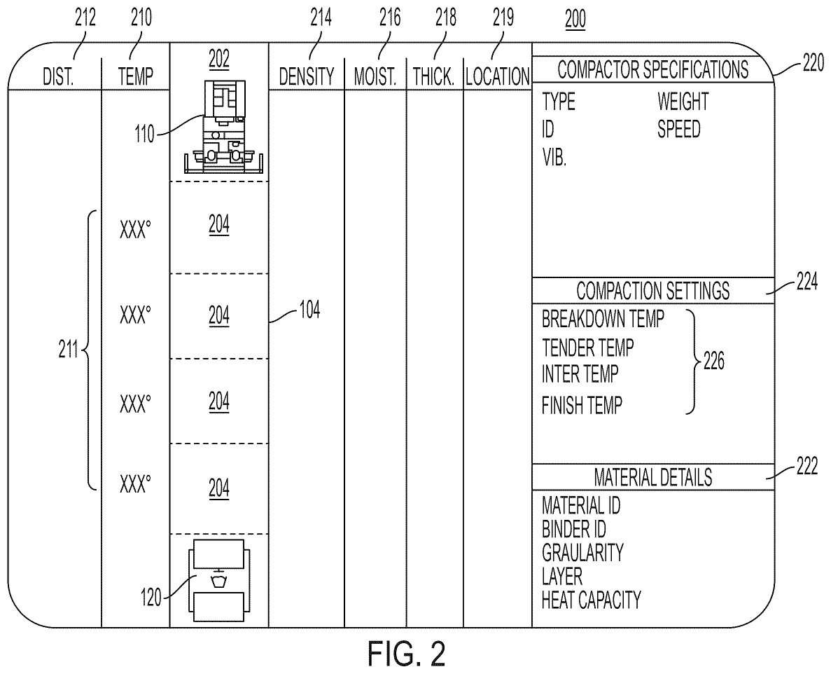

The paving management system 140 can assemble and organize the data and information received about the worksite 100 from the worksite sensors 170 and relate that to the ongoing activities and operations of the mobile machines 101 and worksite personnel 182 during the paving operation. For example, referring to FIG. 2, the paving management system 140 can generate a paving map 200 that associates the data and information with respect to the paving mat 104 and particularly with respect to compaction stages associated with the subordinate compaction operation.

In an example, the paving map 200 can be a visual representation including textual and graphical components presenting the information in a contextually organized arrangement. The paving management system 140 can generate the paving map 200 as a computer readable image that can be communicated and transfer digitally from the worksite server 142 via the worksite transceiver 149. The paving map 200 can be received by the electronic controllers 150 associated with the mobile machines 101 and by worksite personnel 182 and may be visually rendered on the operator interface displays 160. In another example, the aspects and functionality of the paving map 200 can be utilized as a background application without the visual representations. For example, the worksite server 142 can generated the paving map 200 and the onboard electronic controller 150 on the autonomous mobile compactor 120 can utilize the paving map 200 independently of direct operator interaction.

To provide contextual association for the data and information gathered by the paving management system 140, the paving map 200 can include a digital representation 202 of the development of the paving mat 104. The digital representation 202 of the paving mat 104 can be similar to the physical paving mat 104 that may be formed as a continuous elongated path of paving material dispensed over the base surface 106 of the worksite 100. The digital representation 202 can be separated into distinct regions 204 or areas that may be geographically distinguishable or that may be associated with different fabrication and compaction.

The paving map 200 can also include textual field arranged, for example, in columns with respect to the digital representation 202 to present relevant information and data about the paving mat 104. For example, due to the importance of thermal temperature to the characteristics and development of the paving mat 104, the paving map 200 can include a temperature field 210 that is presented alongside the digital representation 202. The temperture field 210 can be textual or graphically color-coded and can be associated with the different distinct regions 204 to indicate the corresponding temperature of the paving mat 104. To provide further context for the temperature field 210, the paving map 200 can include a distance field 212 that indicates the geographic or spatial location of the distinct regions 204 of the digital representation 202, for example, in terms of distance between the paver 110 and the mobile compactors 120.

The temperature field 210 can include assessed temperature values 211 that are indicative of the temperature of the paving mat 104 that may be in suitable terms such as Fahrenheit or Celsius. The assessed temperature values 211 can be correlated with the distinct regions 204 of the digital representation 202 as shown on the paving map 200. The assessed temperature values 211 can be indicative of the current temperature at a particular location of the paving mat 104 or can be predictive of the paving mat temperature at a future state resulting from temporal cooling.

The paving map 200 can include additional fields to present relevant data and information related to the paving mat 104. For example, the paving map 200 can include a density field 214 that includes the density of the paving mat 104 as determined or estimated by the paving management system 140 using data from the worksite sensors 170. The information in the density field 214 can also be indicative of the compaction of the paving mat 104 and the quantity or volume of air voids in the paving material. The density field 214 can be arranged to present the density information in relation to the distinct regions 204 of the digital representation 202.

The paving map 200 can also include a moisture field 216 that includes and presents data about the moisture content of the paving mat 104 that effects development and compaction. The paving map 200 can also include a thickness field 218 that include the dimensional thickness of the paving mat 104 in appropriate units. The thickness of the paving mat 104 may differ by the distinct regions 204 of the digital representation 202. The data in the thickness field 218 can be indicative of the compaction of the paving mat 104.

To provide geographic context for the information presented with respect to the paving mat 104, the paving map 200 can also include a location field 219 that sets forth the geographic spatial locations of the distinct regions 204 of the digital representation 202. The location field 219 can be presented with respect to a coordinate system in terms of latitude and longitude. The data presented in the location field 219 can be obtained in part using the GNSS or GPS system 190.

The paving map 200 can also incorporate information about the mobile machines 101 including, for example, the mobile compactors 120 in a compactor specifications field 220. The compactor specifications field 220 can include and present data about one or more of the mobile compactors 120 such as the type (breakdown, intermediate finishing), identification, operating specifications such as weight and speed, vibration capabilities, etc. The compactor specification field 220 can be for the different mobile compactors 120 that can be used during the paving operation.

To incorporate information about the paving material, the paving map 200 can include a paving material data field 222 that represents material details such as the material type, identification of the aggregate and binder, the granularity, etc. An example of a type of material paving data field 222 can be heat capacity associated with the paving material that can be determinative of the cooling rate and changes in temperature associated with the paving mat 104. The paving material data field 222 can be obtained by the paving management system 140 from the source of the paving materials such as an asphalt plant, for example, by data messages communicated to the worksite server 142.

The paving map 200 can also include compaction settings or thresholds in a compaction settings field 224. The compaction settings field 224 can include the processing information and data for the fabrication of the paving mat 104. For example, the compaction settings field 224 can include the compaction temperature settings 226 that correspond to the temperatures at which the paving material comprising the paving mat 104 are susceptible to compaction. The compaction temperature settings can be discrete temperature values or can be ranges of temperature values as described above. Moreover, the compaction settings field 224 can include the a plurality of compaction temperature settings 226 that may be associated with the breakdown stage, tender stage, intermediate stage, and finishing stage of the subordinate compaction operation.

The paving management operation 140 can determine the information to include in the compaction settings field 222 based on variables and factors input to the worksite server 142 such as the paving material data, the ambient environmental data, the specifications of the mobile compactors 120, and the characteristics and properties of the paving mat 104 such as density and thickness. The worksite server 142 can calculate the compaction temperature settings 226 based on the factors and variable for specific paving material and paving mat 104 being fabricated.

For example, the compaction temperature settings 226 can change depending upon the type or granularity of the paving material, which can be obtained from the paving material data field 222. The compaction temperature settings 226 can also change depending upon the operational specifications of the mobile compactor 120 that can be obtained from the compactor data field 220. For example, the compaction temperature settings 226 for the breakdown stage of the subordinate compaction operation may be higher for a heavier mobile compactor than for a lighter mobile compactor. The compaction temperature settings 226 may also be affected by the specifics of the paving mat 104 including, for example, the dimensional thickness of the paving mat obtained from the thickness field 218.

The information in the compaction settings field 324 can be dynamic and can be continuously processed and updated by the paving management operation 140 based on changes to the input factors and variables.

### Industrial Applicability

The paving management system 140 is configured to facilitate the paving operation in general and particularly compaction of the paving mat 104 as it is constructed about the worksite 100. The disclosure may be particularly applicable and advantageous when the mobile compactors 120 are configured for autonomous operation without the presence or assistance of an operator. For example, using the measurements and information obtained from the plurality of worksite sensors 170, the paving management system 140 can process and analyze the data inputs to determine the compaction characteristics of the paving mat 104 including at the different compaction stages described herein. The paving management system 140 can directed operation of the autonomous mobile compactors 120 accordingly, and particularly during the different compaction stages.

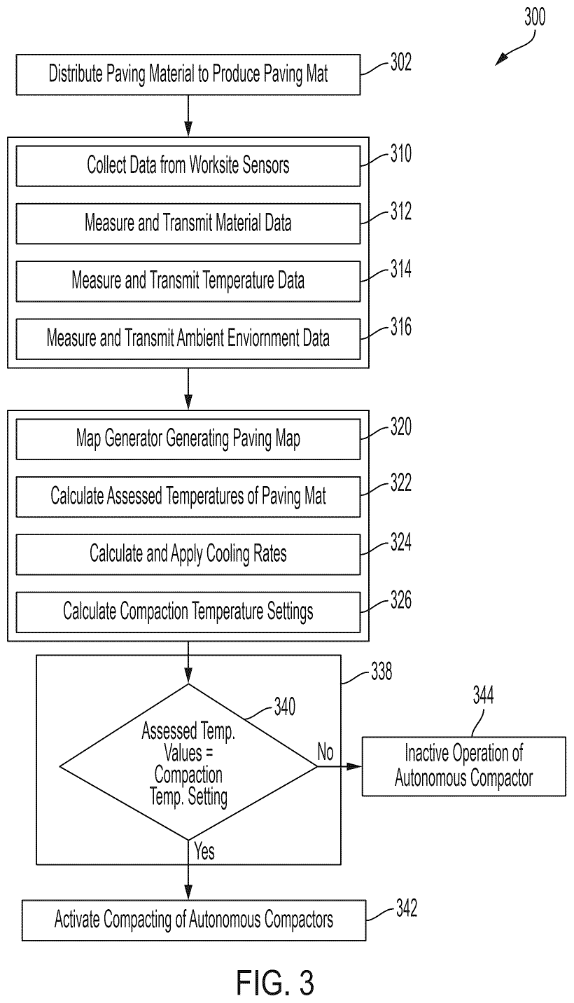

For example, referring to FIG. 3, with continued reference to the prior figures, there is illustrated an example of a computer-implemented paving operation 300 or routine that the paving management system 140 can conduct at the worksite 100 and specifically can direct operation of a fleet of autonomous mobile compactors 120. The process or method for the computer-implement paving operation 300 can be implemented as non-transitory, computer-executable software programs written in any suitable programming language and run on any suitable computer architecture utilizing one or more processors and peripheral devices. The software for performing the paving operation 300 can be executed in part through the worksite server 142.

The paving operation 300 can begin with a material distribution step 302 during which the paving material is dispensed from the paver 110 onto the base surface 106 to produce the paving mat 104 in its initial formation stage. Alternatively, instead of utilizing a paver 110, the paving materials may be directly deposited on the base surface 106 by, for example, the haul truck 118. The material distribution step 302 can be initiated at the direction of the paving management system 140 and can conducted at specific geographic locations about the worksite 100.

To determine the characteristics and properties of the paving mat 104 for subsequently directing the subordinate compaction process, the paving operation 300 involves a data collection step 310 in which data and measurements are gathered by the worksite server 142 for processing and analysis. The data collection step 310 utilizes the plurality of different worksite sensors 170 to obtain the information and measurements about the paving mat 104, the paving materials forming the paving mat, and the ambient conditions associated with the worksite 100. The measurements and detections made by the worksite sensors 170 can be communicated to the worksite server 142 automatically and continuously, or may be output in response to read requests from the paving management system 140.

For example, because the subordinate compaction operation is dependent on the thermal temperature of the paving mat 104, which is further indicative of the different compaction stages, the data collection step 310 can include a temperature measurement sub-step 312 to obtain thermal data about the paving mat 104. The temperature measurement sub-step 312 can be made by the aerial sensors 172 mounted to the airborne machine 174, which may be infrared thermometers capable of making direct temperature measurements of the paving mat 104 from an elevated distance. The airborne machines 174 can be advantageously maneuvered to different locations above the paving mat 104 to measure the temperature of the paving material at different times after distribution from the paver 110 onto the base surface 106. The aerial sensors 172 are thus able to measure the temperature at different regions of the paving mat 104 to assess the appropriate compaction stages for the paving operation 200.

In another example, the temperature measurement sub-step 312 can be conducted by the machine-mounted sensors 180 mounted to the mobile machines 101. For example, the machine-mounted sensor 180 can be mounted to the paver 110 and can measure the temperature of the paving material dispensed by the screed 114. The recently dispensed paving material may be at an elevated temperature and will thermally cool over time in accordance with other factors. In another example, the worksite sensor 170 can be a terrestrial sensor 176 mounted to the rover 178 which can travel over or proximate to the paving mat 104 to collect thermal data.

In the examples wherein the machine-based sensors 180 can be thermometers mounted to the mobile compactors 120, the temperature measurement sub-step 312 can obtain the present temperature to the distinct region of the paving mat 104 proximate to the particular mobile compactor 120. The temperature measurements from the machine-mounted sensor 180 can be combined with the geometric position of the mobile compactor 120 as determined by the GNSS or GPS system 190 to establish the thermal temperate at specific geographic regions of the paving mat 104.

To predict or estimate the change in temperature of the paving mat 104 due to thermal cooling, which may be effected by environmental or ambient factors, the data collection step 310 can also include an ambient environment measurement sub-step 314. The ambient environment measurement sub-step 314 can measure characteristics and parameters about the environment of the worksite 100 such as ambient temperature, humidity, wind velocity, and the like that may affect the temperature, and specifically the temporal change in temperature, of the paving mat 104. The ambient environment measurement sub-step 314 can be conducted by any of the suitable worksite sensors including the aerial sensors 172 and the terrestrial sensors 176.

Because the temperature of the paving materials is also affect by the physical properties of the paving material, the data collection step 310 can also include a material measurement sub-step 316 that obtains the paving material data. For example, the material measurement sub-step 316 can collect data and make measurements about the composition of the paving materials including the aggregate and binders that may determine the heat capacity and cooling rate of the paving materials. The material measurement sub-step 316 can also measure the properties that affect the density and volumetric characteristics of the paving materials and air voids therein and that can be used to estimate the compaction characteristics of the paving mat 104. The paving material data collected by the material measurement sub-step 316 can be communicated to the paving management system 140 from the source of the paving materials, such as an asphalt plant, and input via the data entry terminals 146 of the worksite server 142. Additionally, the paving material data collected by the material measurement sub-step 316 can be obtained by machine-based sensor 180 associated with the haul trucks 118.

To contextually relate the information and data gathered in the data collection step 310 with the paving mat 104, the paving operation 300 can include a paving map generator 320 that generates the paving map 200 of the paving mat 104 described in FIG. 2. For example, the data from the data collection step 310 can be communicated to the paving map generator 320 that may be embodied as a programming routine or module written as computer executable software code and that may reside on and be implemented by the worksite server 142. The paving map generator 320 can analyze and process the data and information to render the paving map 200 including the visual and graphical components shown in FIG. 2, although in other configurations aspects of the paving map 200 can be embodied as a non-visual collection of related data and values that may be used by the paving management system 140 as a background application with limited user interaction.

To calculate and determine the temperature data, specifically the assessed temperatures 211, for the temperature field 210 of the paving map 200, the paving map generator 320 can include a temperature assessment sub-step 322. In an application, the assessed temperature data 211 can directly correspond with the thermal data measured by the worksite sensors 170 and obtained by the temperature measurement sub-step 312. For example, if the worksite sensors 170 are infrared thermometers or the like, the temperature assessment sub-step 322 can directly convert the thermal data to the value of the assessed temperature 211 of the paving mat 104. Further, the temperature assessment sub-step 322 can combine the thermal data with the present location of the worksite sensor, which may be determined using the using the GNSS or GPS system 190, to associate the assessed temperature 211 with the different distinct regions 204 of the digital representation 202 of the paving mat 104 in the paving map 200.

In another aspect, the temperature assessment sub-step 322 can estimate the thermal temperature of the distinct regions 204 of the digital representation 202 of the paving mat 104. The temperature assessment sub-step 322 can process the data obtained by the data collection step 210 by applying rules, definitions, and formulas for determining the temperature of the paving materials. For example, the assessed temperatures 211 and data for the temperature field 210 can be calculated based on the temperature measurement sub-step 312 by the worksite sensors 170 in combination with information from the ambient environment measurement sub-step 314 and the material measurement sub-step 316.

In an example, to assist the temperature assessment sub-step 322, the paving map generator 320 can include a cooling determination sub-step 324 configured to determine a cooling rate to apply to the paving mat 104. After the paving material has been dispensed to form the paving mat 104 over base surface 106, thermal cooling will occur due to convection and/or radiation reducing the temperature of the paving mat 104. The cooling determination sub-step 324 can calculate the cooling rate to apply based on factors and variables like the ambient temperature and humidity obtained by the ambient environment measurement sub-step 314 and heat capacity of the paving material obtained by the material measurement sub-step 316. The temperature assessment sub-step 332 can process the cooling rate by the duration or time that the paving mat 104 is exposure to the environment to assess or estimate the assessed temperature 211 of the distinct region 204 of the digital representation 202.

The assessed temperature 211 can be indicative of the present temperature of the paving mat 104 and can be an estimated temperature at a specific time in the future that paving mat will reach due to thermal cooling. The assessed temperature 211 included among the temperature data 210 in the paving map 200 can represent present temperatures of the distinct regions 204 of the digital representation and estimated temperature at a future time of the distinct regions.

The paving map generator 320 can also include a compaction setting sub-step 326 that determines and assigns the compaction settings 324 for incorporation into the compaction settings field 234 of the paving map 200. As described above, the compaction temperature settings 326 can include a plurality of temperature values or ranges that can correspond to different compaction stages of the subordinate compaction process, including the breakdown, tender, intermediate, and final stages. The compaction temperature settings 226 can be predetermined from historical empirical data and can be stored as a library or data table stored in the data storage 148 associated with the worksite server 142.

In another example, the compaction setting sub-step 326 can be a mathematical operation to calculate the compaction temperature settings 326 for the compaction settings field 234. As described above, the compaction temperature settings 326 can depend upon paving material data, the ambient environmental data, the mobile compactors, and the characteristics and properties of the paving mat 104. The compaction setting sub-step 326 can receive and process the information and data form the data collection step 310 to calculate the compaction temperature settings 326 for the specific embodiment of the paving mat 104 and possibly for the specific distinct regions 204 of the digital representation 202.

The paving operation 300 can utilize the paving map 200 to control operation of the mobile machines 101 and in particular the plurality of mobile compactors 120. For example, the assessed temperatures 211 calculated by the temperature assessment sub-step 322 are indicative of the compaction stage appropriate for the distinct regions of the paving mat 104 as determined by compaction temperature settings 226. The paving operation 300 therefore uses the assessed temperatures 211 and the compaction temperature settings 226 to automatically initiate the different compaction stages performed by the variety of autonomous mobile compactors 120 at the appropriate times and at the appropriate geographic regions or locations of the paving mat 104.

For example, the paving operation 300 can include a temperature comparison step 340 in which the paving management system 140 compares the assessed temperature 211 with the data in the compaction settings field 224 of the paving map 202 that correspond to the different compaction stages such as breakdown, tender, intermediate, and finishing. The temperature comparison step 340 can be executed by the worksite server 142 or may be conducted onboard the mobile compactors by the onboard electronic controllers 150. For example, the temperature comparison step 340 can be part of a comparative routine or module 338 that is written as part of a software application or program and that can reside on either central worksite server 142 or the onboard electronic controller 150 for processing.

If the temperature comparison step 340 determines the assessed temperature 211 corresponds with one of the compaction temperature settings 326 in the compaction settings field 224, the paving operation 300 can proceed to an activation step 342 to automatically initiate operation of one of the mobile compactors 120. For example, if the assessed temperature 211 corresponds with the breakdown temperature of the paving mat 104, the paving management system 140 directs and commands the breakdown compactor 130 to begin traveling over the paving mat 104 in the travel direction 108.

The activation step 342 can include other commands for operation of the breakdown compactor 130, such as activating vibration creating eccentric weights within the compactor rollers 122 to apply vibration forces upon the paving mat 104. The command directions associated with the activation step 342 can be generated and transmitted from the central worksite server 142 to the breakdown compactor 130 or can be initiated by the onboard electronic controller 150.

If the temperature comparison step 340 determines the assessed temperature 211 does not correspond with any of the compaction temperatures settings 226 associated with the compaction stages, or determines that the assessed temperature 211 corresponds with the tender stage, the paving operation 300 can proceed to in inactive step 344. The inactive step 344 can be characterized by commanded inactivity of the respective autonomous mobile compactor 120 with respect to the subordinate compacting operations of compacting the paving mat 104. For example, the inactive step 244 can stall or delay travel of the mobile compactors 120 along the paving mat 104. In another example, if the temperature comparison step 340 determines the assessed temperature 211 is approaching or within the tender zone, the inactive step 344 can command autonomous operation of the breakdown compactor 130 to cease, and may further direct the breakdown compactor 130 to travel off or away from the respective distinct region of the paving mat 104

The inactive step 344 can be characterized by commanding or directing other functions and operations of the autonomous mobile compactors 120. For example, temperature comparison step 340 can be a continuous, repetitive step that continually compares the assessed temperatures 211 with the compaction temperature settings 326. The inactive step 344 can therefore function as a delay during with the autonomous mobile compactor 120 waits while the thermal temperature of the paving mat 104 cools to an appropriate range for a respective compaction stage.

The activation step 342 and the inactive steps 344 can be embodied as command signals generated by the programming associated with the comparative routine/module 338 that conducts the comparison step 340. The commands for the activation and inactive steps 342, 344 can be transmitted from the central worksite server 142 or can originate from the onboard electronic controller 150 on the mobile compactors 120.

In another example, the paving management system 140 can direct the paving operation 300 to simultaneously operate a plurality of mobile compactors 120 to sequentially conduct the compaction stages of the subordinate compaction operation. For example, the temperature comparison step 340 can be conducted for the assessed temperature 211 associated with each distinct region 204 of the digital representation 204 of the paving mat 104. Further, the temperature comparison step 340 can compare the assessed temperatures 211 with the values and/or ranges of different compaction temperature settings 226 to determine if a particular distinct region 204 corresponds with a specific compaction stage such as the breakdown stage, tender stage, intermediate stage, or finishing stage.

The paving operation 300 may determine that the assessed temperature 211 of the distinct region 204 closest or proximate to the paver 110, hence the highest, corresponds with the breakdown stage. The activation step 342 can command the breakdown compactor 130 to initiate compacting of the area of the compaction mat 104 corresponding to the distinct region 204 at the elevate assessed temperature 211.

The paving operation 300 may also simultaneously determine the assessed temperature 211 of a second distinct region 204 further from the paver 110 corresponds to the compaction temperature settings 226 for the intermediate or finishing stages. The activation step 342 can command the intermediate or finishing compactors 132, 134 to initiate compaction of those distinct regions 204 of the paving mat 104. The paving operation 300 can simultaneously manage and direct operation of a plurality of different mobile compactors 120 to conduct the sequential stages of the subordinate compaction process.

In a further example, the paving management system 140 can use the information in paving map 200 to generate additional directions and commands for operation of the autonomous compacting machines 120. For example, because the assessed temperature 211 in the temperature field 210 can be predictive of the thermal temperature that the distinct region 204 will reach at a future time, the paving management system 140 can direct the autonomous mobile compactor 120 to travel to and arrive at distinct region 204 in anticipation of the assessed temperature instating a specific compaction stage.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of autonomous paving comprising:
distributing a paving material over a base surface to produce a paving mat;
obtaining thermal data from a worksite sensor about the paving mat;
generating a paving map of the paving mat including an assessed temperature value derived from the thermal data; and
activating an autonomous mobile compactor to compact the paving mat upon correspondence between the assessed temperature value from the paving map and a compaction temperature setting.

2. The method of claim 1, wherein the compaction temperature setting includes compaction temperature value for a breakdown stage, a tender stage, and a finishing stage of a subordinate compaction operation.

3. The method of claim 2, further comprising:
activating a breakdown compactor to compact a first distinct region having the assessed temperature value corresponding to the compaction temperature value for the breakdown stage; and
activating a finishing compactor to compact a second distinct region having the assessed temperature value corresponding to the compaction temperature value for the finishing stage.

4. The method of claim 3, further comprising deactivating the breakdown compactor if the first distinct region has the assessed temperature value corresponds to the compaction temperature value for the tender stage.

5. The method of claim 4, further comprising calculating the compaction temperature setting based on one or more of on one or more of compactor specifications data, paving material data, and paving mat thickness.

6. The method of claim 1, further comprising navigating an airborne machine mounted to the worksite sensor above the paving mat.

7. The method of claim 6, wherein the assessed temperature value corresponds directly to the thermal data obtained from the worksite sensor.

8. The method of claim 1, further comprising calculating the assessed temperature value by applying cooling rate to the thermal data obtained by the worksite sensor.

9. A computer-implemented paving management system comprising:
a worksite sensor measuring thermal data about a paving mat;
a central worksite server communicatively receiving the thermal data from the worksite sensor, the central worksite server configured to generate a paving map of the paving mat including an assessed temperature value based on the thermal data; and
a comparative module/routine configured to compare the assessed temperature value with a compaction temperature setting; comparative module/routine further configured to activate operation of an autonomous mobile compactor upon correspondence between assessed temperature values and the compaction temperature setting.

10. The paving management system of claim 9, wherein the assessed temperature value corresponds directly to the thermal data received from the worksite sensor.

11. The paving management system of claim 10, wherein the worksite sensor is an aerial sensor mounted to an airborne machine.

12. The paving management system of claim 10, wherein the worksite sensor is a machine-mounted sensor mounted to the autonomous mobile compactor.

13. The paving management system of claim 10, wherein the worksite sensor is a terrestrial sensor mounted to a rover adapted to travel proximate to the paving mat.

14. The paving management system of claim 9, wherein the assessed temperature value is calculated by applying cooling rates to the thermal data obtained from the worksite sensor.

15. The paving management system of claim 14, wherein the worksite sensor is a machine-mounted sensor mounted to a paver dispensing the paving mat.

16. The paving management system of claim 9, wherein the compaction temperature setting includes compaction temperature values for one or more of a breakdown stage, a tender stage, an intermediate stages, and a finishing stage of a subordinate compaction operation.

17. The paving management system of claim 16, wherein the worksite server is configured to calculate the compaction temperature setting based on one or more of compactor specifications data, paving material data, and paving mat thickness.

18. The paving management system of claim 9, wherein the paving map include a plurality of distinct regions and the worksite server generates the assessed temperature value for each of the plurality of distinct regions.

19. The paving management system of claim 9, wherein the comparative module/routine is located on the central worksite server.

20. The paving management system of claim 9, wherein the comparative module/routine is located on an onboard electronic controller of the autonomous mobile compactor.
